(19) United States
(12) Patent Application Publication
(10) Pub. No.: US 2003/0071037 A1
(43) Pub. Date: Apr. 17, 2003

(54) Microwave sintering furnace and microwave sintering method

(76) Inventors: Motoyasu Sato, Shiga-gun (JP); Sadatsugu Takayama, Tajimi-shi (JP); Masatoshi Mizuno, Tajimi-shi (JP); Kazunari Okumura, Anjyo-city (JP); Akira Kagohashi, Toki-city (JP); Akira Nishio, Toki-city (JP); Toshio Sato, Higashisonogi-gun (JP); Hiroyuki Matsuo, Sendai-city (JP); Hiromichi Ohtaki, Sendai-city (JP); Yukio Kishi, Sendai-city (JP)

Correspondence Address: NIXON & VANDERHYE P.C., 8th Floor, 1100 North Glebe Road, Arlington, VA, 22201, US

(21) Appl. No.: 10/233,778

(22) Filed: Sep. 4, 2002

(30) Foreign Application Priority Data
Sep. 5, 2001 (JP) 2001-268433 (PAT.

(51) Int. Cl. H05B 6/80

(52) U.S. Cl. 219/731; 219/687

(57) ABSTRACT

A microwave sintering furnace and a microwave sintering method are disclosed, in which the object to be sintered develops no cracking or deformation in the degreasing process. A microwave sintering furnace (1) comprises a furnace body (2) containing an object (S) to be sintered, a unit (3, 4) for generating and introducing microwaves into the furnace body, a unit (8) for supplying a degreasing gas into the furnace body (2), and a unit (11) for heating the degreasing gas before it reaches the object (S) to be sintered.

### BACKGROUND OF THE INVENTION

1. Field of the Invention

The present invention relates to a microwave sintering furnace and a microwave sintering method for sintering an object to be sintered, such as a ceramic object, by microwave heating.

2 Description of the Related Art

In recent years, a technique for sintering ceramics by microwave heating has been developed and variously proposed. As a technique for preventing a temperature gradient which may be caused in the object to be sintered by microwave heating, for example, U.S. Pat. No. 2,654,903 discloses a method of sintering an object to be sintered, with microwaves, in which the object is preheated in a microwave sintering furnace and sintered with microwave while controlling the temperature difference between the interior of the furnace and the surface of the object to be sintered.

In the case where the object to be sintered contains an organic substance such as a binder for maintaining the shape, on the other hand, the decomposed gas of the organic substance stays around the object, which is thus exposed to a reducing atmosphere. As a result, part of the organic substance may remain as carbon. Normally, however, the decomposed gas is prevented from remaining by introducing a degreasing gas at a normal temperature.

Nevertheless, in the case where the degreasing gas at normal temperature is introduced into the furnace for performing the degreasing process by microwave heating, a problem is posed that the object to be sintered is cracked or deformed and, in the worst case, ruptured.

### SUMMARY OF THE INVENTION

The prevent invention has been achieved in view of the situation described above, and the object thereof is to provide a microwave sintering furnace and a microwave sintering method in which the object to be sintered is not cracked or deformed by the degreasing process.

The present inventors have studied how to prevent the cracking or deformation of the object to be sintered when degreased by microwave heating. As a result, the inventors have reached the conclusion that the cracking or deformation in the degreasing process is caused by the fact that the decomposed gas, of an organic substance such as a binder, generated in the object to be sintered is solidified on the surface of the object and not scattered. Specifically, the water and the organic binder contained in the object to be sintered are most easily heated by microwave heating, so that the internal temperature of the object increases to a high level while the peripheral area of the object remains at a low temperature. The surface temperature of the object to be sintered is further reduced by the degreasing gas at normal temperature supplied thereto, with the result that the organic substance is prevented from being decomposed, oxidized or scattered, thereby leading to the cracking or deformation of the object.

As a consequence of a further study for preventing these inconveniences, the inventors have discovered that it is effective to heat the degreasing gas before it is supplied to the object to be sintered. This invention has been completed based on this knowledge.

According to one aspect of the invention, there is provided a microwave sintering furnace comprising a furnace body containing an object to be sintered, means for generating and introducing microwaves into the furnace body, means for supplying a degreasing gas into the furnace body, and means for heating the degreasing gas before it reaches the object to be sintered.

The heating means may be a heater for heating the degreasing gas from the degreasing gas source before it reaches the furnace body. This heating means preferably includes means for measuring the temperature of the object contained in the furnace body and means for controlling the heater based on the temperature measured by the temperature measuring means and thus controlling the temperature of the degreasing gas supplied to the object. In this way, the temperature of the degreasing gas can be changed in accordance with the object in the furnace body, so that the temperature of the degreasing gas supplied can be maintained always at a level higher than the temperature of the object to be sintered, thereby very effectively preventing the temperature of the object from being decreased by the degreasing gas and the decomposed gas from being solidified.

The heating means may alternatively include a heating member made of a porous material arranged in the furnace body and heated by microwaves, so that the degreasing gas is supplied to the object after passing through the heating member.

The furnace body preferably includes at least two layers of insulating members outside the space in which the object to be sintered is arranged, with the innermost insulating member having a microwave absorption characteristic identical or similar to that of the object to be sintered. As a result, the temperature difference between the exterior and the interior of the object to be sintered can be reduced to achieve uniform sintering. The outer insulating member preferably has a smaller specific heat.

According to another aspect of the invention, there is provided a microwave sintering method for sintering an object with microwave heating, comprising the steps of supplying a degreasing gas to the object while heating the object with microwaves, and stopping the supply of the degreasing gas and sintering the object by heating it with microwaves, wherein the degreasing step includes the step of heating the degreasing gas before it is supplied to the object to be sintered.

In the degreasing step of the microwave sintering method described above, the porous material is preferably heated with microwaves, together with the object to be sintered, and the degreasing gas passed through the porous material is supplied to the object.

### BRIEF DESCRIPTION OF THE DRAWINGS

FIG. 1 is a sectional view showing a general configuration of a microwave sintering furnace according to an embodiment of the invention.

FIG. 2 is a sectional view showing a general configuration of a microwave sintering furnace according to another embodiment of the invention.

### DESCRIPTION OF THE PREFERRED EMBODIMENTS

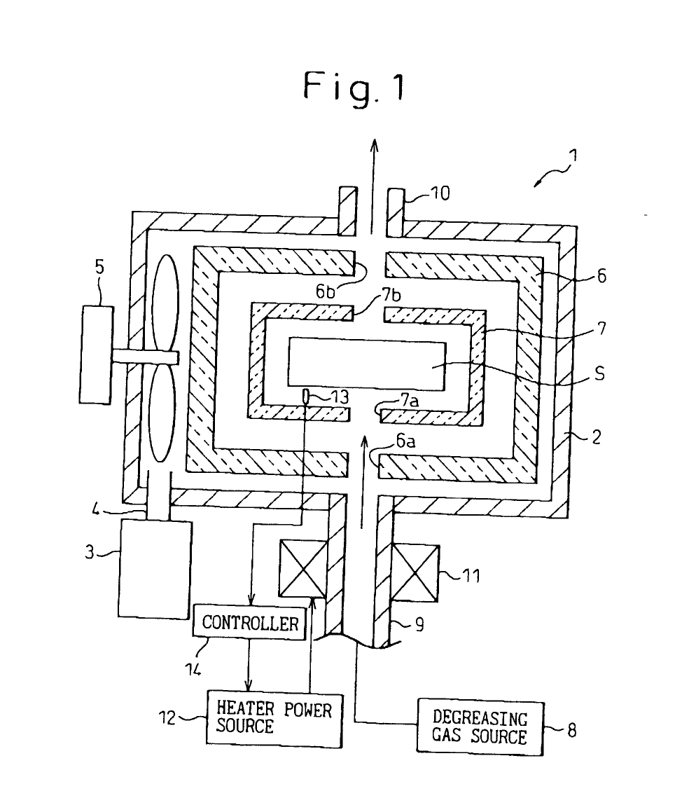

Embodiments of the invention will be explained specifically below with reference to the accompanying drawings. FIG. 1 is a sectional view showing a microwave sintering furnace according to an embodiment of the invention. The microwave sintering furnace 1 comprises a box-shaped furnace body 2 of stainless steel, a microwave oscillator 3 arranged outside the furnace body 2, a waveguide 4 for leading the microwaves into the furnace body 2, a microwave agitator 5 for agitating the microwaves in the furnace body 2, a degreasing gas source 8 for supplying a degreasing gas into the furnace body 2 and a heater 11 for heating the degreasing gas before it is led into the furnace body 2.

Two insulating members including an outer insulating member 6 and an inner insulating member 7 are arranged in the furnace body 2. The space defined by the inner insulating member 7 forms the space in which an object S to be sintered is arranged. The inner insulating member 7 is made of a material having a microwave absorption characteristic identical or similar to that of the object S, or typically, is the same material as the object S. The outer insulating member 6, on the other hand, preferably is made of a material having small specific heat such as ceramic wool.

The degreasing gas source 8 is connected to a degreasing gas lead pipe 9, through which the degreasing gas is led into the furnace body. The heater 11 is arranged around the portion of the degreasing gas lead pipe 9 immediately before reaching the furnace body 2. A degreasing gas discharge pipe 10 for discharging the degreasing gas is connected to the surface portion of the furnace body 2 far from the surface portion thereof connected with the degreasing gas lead pipe 9. The portions of the outer insulating member 6 and the inner insulating member 7 nearer to the degreasing gas introduction side, to which the degreasing gas is led, are formed with degreasing gas introduction holes 6a, 7a, respectively. The degreasing gas is led through the degreasing gas introduction holes 6a, 7a into the space in which the object to be sintered is arranged. The portions of the outer insulating member 6 and the inner insulating member 7 where the degreasing gas is discharged, on the other hand, are formed with degreasing gas discharge holes 6b, 7b, respectively. The degreasing gas that has contributed to the process for degreasing the object S is discharged into the degreasing gas discharge pipe 10 through the degreasing gas discharge holes 6b, 7b.

The heater 11 is connected to a heater power source 12 and generates heat from power supplied from the heater power source 12. The output of the heater power source 12 is controlled by a controller 14. A temperature measuring instrument 13 such as a thermocouple or a radiation pyrometer is arranged in the neighborhood of the object S to be sintered. The measurement signal of the temperature measurement instrument 2 is output to the controller 14, based on the value of the measurement signal, and controls the heater power source 12 to thereby control the temperature of the degreasing gas heated by the heater 11.

In the microwave sintering furnace 1 configured as described above, the furnace lid not shown is opened and the object S is arranged in the furnace body 2, and then the furnace lid is closed to start the process.

First, the degreasing step is carried out. In the degreasing step, the microwave generated by the microwave oscillator 3 is led into the furnace body 2 through the waveguide 4. Thus, the object S is heated by microwave and degreased while being agitated by the microwave agitator 5. In the process, the degreasing gas is introduced into the furnace body 2 from the degreasing gas source 8 through the degreasing gas lead pipe 9.

The degreasing gas is introduced into the furnace body 2 at a high temperature immediately after being heated by the heater 11 and, through the degreasing gas lead holes 6a, 7a, reaches the object S to be sintered. The decomposed gas of an organic material such as a binder generated from the object S is discharged into the decreasing gas discharge pipe 10 through the degreasing gas discharge holes 6b, 7b together with the degreasing gas. The degreasing gas used for this purpose includes air, oxygen gas or the like gas which positively decomposes the organic material such as a binder or the nitrogen gas, argon gas or the like inert gas having the function of carrying the gas generated by decomposition.

By supplying the object S with the degreasing gas heated by the heater 11 as described above, the temperature drop of the surface of the object S is suppressed, thereby the decomposition, oxidization or scattering of the organic substance is prevented from being hampered.

Based on the measurement value of the temperature measuring instrument 13, the controller 14 controls the heating of the degreasing gas by the heater 11 and thereby controls the temperature of the degreasing gas. Thus, the temperature of the degreasing gas supplied to the object S can be controlled very effectively in accordance with the temperature of the object S. Preferably, the temperature of the degreasing gas supplied to the object S is controlled in such a manner as to assure a gradual temperature increase of the object S in the degreasing process. As a result, the decomposition, oxidization or scattering of the organic substance can be prevented completely from being hampered.

In view of the fact that the decomposition, oxidization or scattering of the organic substance can be prevented from being hampered, as described above, the decomposed gas generated in the object S is rapidly scattered out of the object S, thereby preventing the object S from being cracked or deformed in the degreasing process.

The degreasing process is carried out by beating the interior of the furnace body 2 to a predetermined temperature with microwaves and maintaining it at the same temperature for a predetermined length of time. upon completion of this degreasing process, the object S to be sintered is transferred to the sintering process. In the sintering process, the degreasing gas is stopped and the output of the microwave oscillator 3 is increased. Thus, the temperature of the object S in the furnace body 2 is increased at a predetermined rate, and held at a level corresponding to the material of the object S for a predetermined length of time. As a result, the desired sintered member is obtained. In view of the fact that the double insulating members including the outer insulating member 6 and the inner insulating member 7 are used in the furnace body 2 and the inner insulating member 7 is formed of a material having the microwave absorption characteristic identical or similar to that of the object S, the temperature difference between the exterior and the interior of the object S can be maintained at a small value at the time of sintering and, therefore, uniform sintering can be achieved.

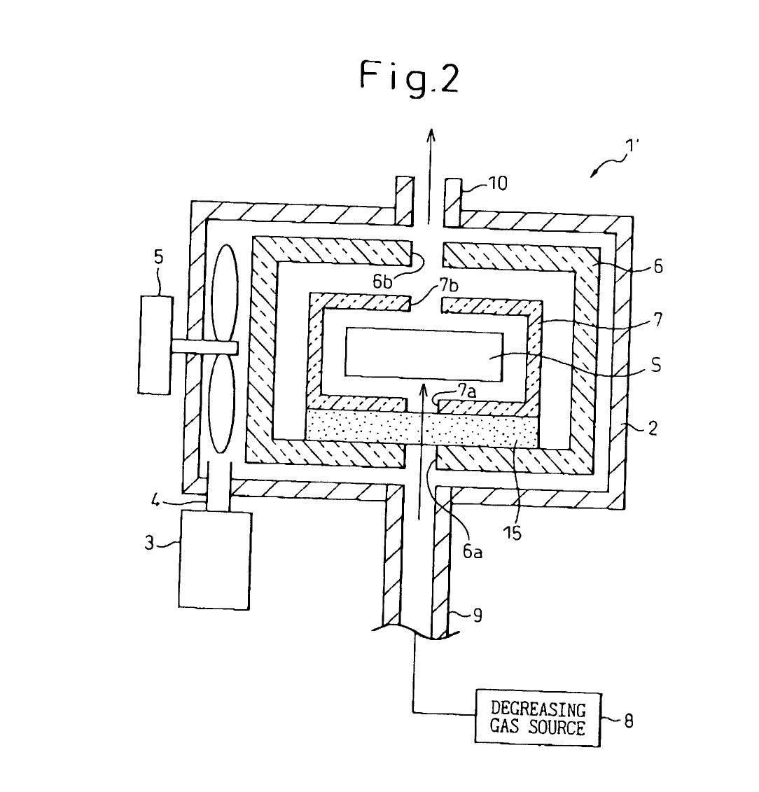

Next, another embodiment of the invention will be explained. FIG. 2 is a sectional view showing a microwave sintering furnace according to another embodiment of the invention. The microwave sintering furnace 1′ has a basic configuration similar to that of the microwave sintering furnace 1 shown in FIG. 1. Therefore, the same component parts as those in FIG. 1 are designated by the same reference numerals, respectively, and will not be explained again.

According to this embodiment, the heater 11 used in the embodiment described above as a means for heating the degreasing gas is replaced by a heating member 15 arranged immediately before the space where the object to be sintered is placed in the furnace body 2 The heating member 15 is composed of a porous material heated by microwaves. In this embodiment, the heater power source 12, the temperature measuring instrument 13 and the controller 14 shown in FIG. 1 are not required.

Also in the microwave sintering furnace 1′ according to this embodiment, a sintered member is fabricated basically through the degreasing process and the sintering process as in the embodiment described above. In the degreasing process, as in the embodiment described above, the microwaves generated by the microwave oscillator 3 are introduced into the furnace body 2 through the waveguide 4, and agitated by the microwave agitator 5. At the same time, the object S to be sintered is heated with microwaves and degreased while introducing the degreasing gas into the furnace 2 through the degreasing gas lead pipe 9 from the degreasing gas source 8.

The degreasing gas led into the furnace body 2 reaches the heating member 15 through the degreasing gas introduction hole 6a. Since the heating member 15 is heated by microwaves, the degreasing gas is heated by the heating member 15, and the degreasing gas thus heated is supplied to the object S to be sintered. As a result, the decomposition, oxidization or scattering of the organic substance can be prevented substantially completely from being hampered.

In view of the fact that the decomposition, oxidization or scattering of the organic substance on the surface of the object S to be sintered can be prevented from being hampered, as described above, the decomposed gas generated in the object S is rapidly scattered out of the object S, thereby preventing the object S from being cracked or deformed in the degreasing process.

Upon completion of this degreasing process, the object S is transferred to the sintering process. The sintering process is carried out through exactly the same procedure as in the embodiment described above Specifically, the degreasing gas is stopped and the output of the microwave oscillator 3 is increased. Thus, the temperature of the object S in the furnace body 2 is increased at a predetermined rate, and is maintained at a temperature level corresponding to the material of the object S for a predetermined length of time. As a result, the desired sintered member is obtained.

The present invention is not confined to the embodiments described above, but is variously modifiable. Although the embodiment first described above is so configured that the temperature of the degreasing gas is controlled in accordance with the temperature of the object to be sintered, for example, this control mechanism is not necessarily required. Also, in the double structure of he inner and outer insulating members, it is not always necessary to employ the inner insulating member of a material having the microwave absorption characteristic identical or similar to that of the object to be sintered.

[Embodiments]

Embodiments of the invention will be described below.

The objects of various materials and shapes shown in Table 1 were sintered at the temperatures shown in Table 1 after degreasing them while introducing a degreasing gas. In the first to eighth embodiments shown in Table 1, the degreasing gas is supplied by being heated with the heating means described in FIG. 1 or 2, while the degreasing gas is introduced at normal temperature without being heated in the comparative examples 1, 2. The sintered ceramic material thus fabricated was observed for any defects including cracking and deformation and the density thereof was measured. The result is also shown in Table 1.

TABLE 1

| | | | | | Object to | | | | Density of |
|---|---|---|---|---|---|---|---|---|---|
| | | Introduced gas | | | be sintered | | | | sintered |
| | | Heating | | | | | Sintering | Defect of | member (/× |
| | | means | Type | Temp | Material | Shape | temp | sintered member | 10³ kg · cm⁻³) |
| Embodiment | 1 | | Air | Same as temp of | Zirconia | φ180 × t50 mm | 1500° C. | Nil | 5.95 |
| | | | | sintered member | | | | | |
| | 2 | | Air | Temp of | Alumina | [symbol] 300 × t3 mm | 1600° C. | Nil | 3.92 |
| | | | | sintered member | | | | | |
| | | | | plus 10° C. | | | | | |
| | 3 | | Oxygen | — | Alumina | φ180 × t50 mm | 1600° C. | Nil | 3.91 |
| | 4 | | Air | Same as temp of | Cordierite | Honeycombed | 1380° C. | Nil | 0.25*² |
| | | | | sintered member | | structure*¹ | | | |
| | 5 | | Nitrogen | Same as temp of | Si₃N₄ | φ250 × t20 mm | 1700° C. | Nil | 3.22 |
| | | | | sintered member | | | | | |
| | 6 | | Nitrogen | — | AlN | φ300 × t30 mm | 1800° C. | Nil | 3.29 |
| | 7 | | Ar | — | SiC | φ250 × t20 mm | 2100° C. | Nil | 3.19 |
| | 8 | | Air | — | PZT | [symbol] 40 × t2 mm | 1250° C. | Nil | 7.68 |
| Comparative | 1 | Nil | Air | Normal temp | Zirconia | φ180 × t50 mm | 1500° C. | Crack | 4.10 |
| example | | | | | | | | (rupture) | |
| | 2 | Nil | Air | Normal temp | Cordierite | Honeycombed | 1380° C. | Crack | 0.24*² |
| | | | | | | structure*¹ | | (longitudinal) | |

*¹φ103 × H130, cell pitch: 1.27, cell thickness: 0.09
*²Apparent density including shape

As shown in Table 1, according to the first to eighth embodiments of the invention in which the degreasing gas is heated, the sintered member develops no defects such as cracking or deformation and is sufficiently solidified. In the first and second comparative examples with the degreasing gas introduced at normal temperature without being heated, in contrast, the sintered member develops cracks. Especially in the first comparative example, a rupture occurs and the solidification is not sufficient. This confirms that a sound sintered member can be produced without any cracking or deformation by heating the degreasing gas as according to the invention.

It will thus be understood from the foregoing description that, according to this invention, the degreasing gas is heated by the heating means before being supplied to the object to be sintered. Therefore, the degreasing gas at a high temperature is supplied to the object, and the decomposition, oxidization or scattering of the organic substance is prevented from being hampered by the degreasing gas. Thus, the decomposed gas generated in the object to be sintered is rapidly scattered outside of the object, thereby preventing the sintered member from being cracked or deformed in the degreasing process.

What is claimed is:

1. A microwave sintering furnace comprising;
a furnace body containing an object to be sintered;
means for generating and introducing microwaves into said furnace body;
means for supplying a degreasing gas into said furnace body, and;
means for heating said degreasing gas before reaching said object to be sintered.

2. A microwave sintering furnace according to claim 1,
wherein said heating means includes a heater for heating said degreasing gas from said degreasing gas supply means before reaching said furnace body.

3. A microwave sintering furnace according to claim 2, further comprising:
means for measuring the temperature of said object contained in said furnace body, and
means for controlling the temperature of the degreasing gas supplied to said object by controlling said heater based on the temperature measured by said temperature measuring means.

4. A microwave sintering furnace according to claim 1,
wherein said heating means includes a heating member arranged in said furnace body and made of a porous material heated by microwaves, said degreasing gas being supplied to said object after passing through said heating member.

5. A microwave sintering furnace according to claim 1,
wherein said furnace body includes at least two layers of insulating members outside the space in which said object to be sintered is arranged, and the innermost insulating member has a microwave absorption characteristic identical or similar to that of said object to be sintered.

6. A microwave sintering furnace according to claim 2,
wherein said furnace body includes at least two layers of insulating members outside the space in which said object to be sintered is arranged, and the innermost insulating member has a microwave absorption characteristic identical or similar to that of said object to be sintered.

7. A microwave sintering furnace according to claim 3,
wherein said furnace body includes at least two layers of insulating members outside the space in which said object to be sintered is arranged, and the innermost insulating member has a microwave absorption characteristic identical or similar to that of said object to be sintered.

8. A microwave sintering furnace according to claim 4,
wherein said furnace body includes at least two layers of insulating members outside the space in which said object to be sintered is arranged, and the innermost insulating member has a microwave absorption characteristic identical or similar to that of said object to be sintered.

9. A microwave sintering method for sintering an object with microwave heating, comprising the steps of:
supplying a degreasing gas to said object while heating said object with microwaves; and
stopping the supply of said degreasing gas and sintering said object by heating it with microwaves;
wherein said degreasing step includes the step of heating and supplying said degreasing gas to said object to be sintered.

10. A microwave sintering method according to claim 7,
wherein said degreasing step includes the step of heating the porous material by microwaves together with said object to be sintered, and supplying said object with the degreasing gas passed through said porous material.
